(19) United States
(12) Patent Application Publication
(10) Pub. No.: US 2025/0081077 A1
(43) Pub. Date: Mar. 6, 2025

(54) METHOD AND APPARATUS FOR HANDOVER

(71) Applicant: Lenovo (Beijing) Limited, Beijing (CN)

(72) Inventors: Lianhai Wu, Beijing (CN); Mingzeng Dai, Shanghai (CN); Haiming Wang, Beijing (CN); Min Xu, Beijing (CN); Jie Hu, Beijing (CN)

(73) Assignee: Lenovo (Beijing) Limited, Beijing (CN)

(21) Appl. No.: 18/725,985

(22) PCT Filed: Jan. 4, 2022
(86) PCT No.: PCT/CN2022/070123

§ 371 Date: Jul. 1, 2024

(51) Int. Cl. H04W 36/36; H04W 36/00

(52) U.S. Cl. CPC H04W 36/362; H04W 36/0055

(57) ABSTRACT

Embodiments of the present disclosure relate to methods and apparatuses for handover in a communication system. According to some embodiments of the disclosure, a UE may: receive, from a first BS, a reconfiguration message for handover, wherein the reconfiguration message indicates a direct path to a target cell and an indirect path to a target relay, and the target cell and target relay are served by a second BS; and perform a handover procedure based on the reconfiguration message.

### TECHNICAL FIELD

Embodiments of the present disclosure generally relate to communication technology, and more particularly to handover in a communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via an sidelink, rather than being linked through the BS. A relaying function based on a sidelink may be supported in a communication network. For example, a UE supporting sidelink communication may function as a relay node to extend the coverage of a BS. An out-of-coverage or in-coverage UE may communicate with a BS via a relay UE. In the context of the present disclosure, a UE, which functions as a relay between another UE and a BS, may be referred to as a UE-to-network (U2N) relay.

There is a need for efficiently performing communication in a communication system supporting a U2N relay.

### SUMMARY

Some embodiments of the present disclosure provide a user equipment (UE). The UE may include: a transceiver; and a processor coupled to the transceiver. The processor may be configured to: receive, from a first base station (BS), a reconfiguration message for handover, wherein the reconfiguration message indicates a direct path to a target cell and an indirect path to a target relay, and the target cell and target relay are served by a second BS; and perform a handover procedure based on the reconfiguration message.

In some embodiments, the processor may be further configured to in response to any one of the direct path and the indirect path being successful established, transmit a reconfiguration complete message via a successful established path. The processor may be further configured to in response to one of the direct path and the indirect path being unsuccessfully established, transmit information related to the failed path via the successfully established path.

In some embodiments, one of the direct path and the indirect path may be a primary path. The processor may be further configured to transmit a reconfiguration complete message via the primary path in response to the primary path being successfully established. In some embodiments, the processor may be further configured to in response to the other one of the direct path and the indirect path being unsuccessfully established, transmit information related to the failed path via the primary path. In some embodiments, the processor may be further configured to: in response to receiving the reconfiguration message for handover, start a timer for primary path establishment; and in response to the expiry of the timer for primary path establishment, perform a reestablishment procedure.

In some embodiments, the handover may be considered as successful in response to the direct path being successfully established. In some embodiments, the processor may be further configured to in response to the indirect path being unsuccessfully established, transmit information related to the failed path via the direct path. In some embodiments, the processor may be further configured to: in response to receiving the reconfiguration message for handover, start a timer for direct path establishment; and in response to the expiry of the timer for direct path establishment, perform a reestablishment procedure.

In some embodiments, performing a handover procedure based on the reconfiguration message may include: establishing the indirect path to the second BS via the target relay; and in response to completing the establishment of the indirect path, establishing the direct path with the target cell and starting a timer for direct path establishment.

In some embodiments, the processor may be further configured to in response to the direct path and the indirect path being successfully established, transmit a reconfiguration complete message via one of the direct path and the indirect path. In some embodiments, performing a handover procedure based on the reconfiguration message may include: establishing the direct path to the target cell; and in response to completing the establishment of the direct path, establishing the indirect path and starting a timer for indirect path establishment. In some embodiments, the processor may be further configured to: in response to receiving the reconfiguration message for handover, start a timer for indirect path establishment and a timer for direct path establishment; and in response to the expiry of any one of the timer for indirect path establishment and the timer for direct path establishment, perform a reestablishment procedure.

In some embodiments, the information related to the failed path may indicate an ID of the target cell or the target relay with which the UE fails to establish a link. In some embodiments, the information related to the failed path may be transmitted via a radio resource control (RRC) reconfiguration complete message, a UE assistance information message, or an RRC message specific for the information related to the failed path.

Some embodiments of the present disclosure provide a base station (BS). The BS may include: a transceiver; and a processor coupled to the transceiver. The processor may be configured to: receive a handover request for handing over a user equipment (UE) from another BS to the BS; and transmit a handover request acknowledgement in response to the handover request, wherein the handover request acknowledgement indicates a direct path to a target cell of the BS and an indirect path to a target relay served by the BS.

In some embodiments, the handover request may include information related to a direct path and an indirect path between the UE and the another BS. In some embodiments, the processor may be further configured to receive, from the UE, a radio resource control (RRC) message, which may indicate information related to a failure in establishing at least one of the direct path and the indirect path. In some examples, the information related to the failure may indicate an ID of the target cell or the target relay with which the UE fails to establish a link. In some examples, the RRC message may be an RRC reconfiguration complete message, a UE assistance information message, or an RRC message specific for the information related to the failure.

Some embodiments of the present disclosure provide a method performed by a user equipment (UE). The method may include: receiving, from a first base station (BS), a reconfiguration message for handover, wherein the reconfiguration message indicates a direct path to a target cell and an indirect path to a target relay, and the target cell and target relay are served by a second BS; and performing a handover procedure based on the reconfiguration message.

Some embodiments of the present disclosure provide a method performed by a base station (BS). The method may include: receiving a handover request for handing over a user equipment (UE) from another BS to the BS; and transmitting a handover request acknowledgement in response to the handover request, wherein the handover request acknowledgement indicates a direct path to a target cell of the BS and an indirect path to a target relay served by the BS.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of a wireless communication system in accordance with some embodiments of the present disclosure;

FIG. 3 illustrates a flow chart of an exemplary procedure of wireless communications in accordance with some embodiments of the present disclosure;

FIG. 4 illustrates a flow chart of an exemplary procedure of wireless communications in accordance with some embodiments of the present disclosure; and

FIG. 5 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

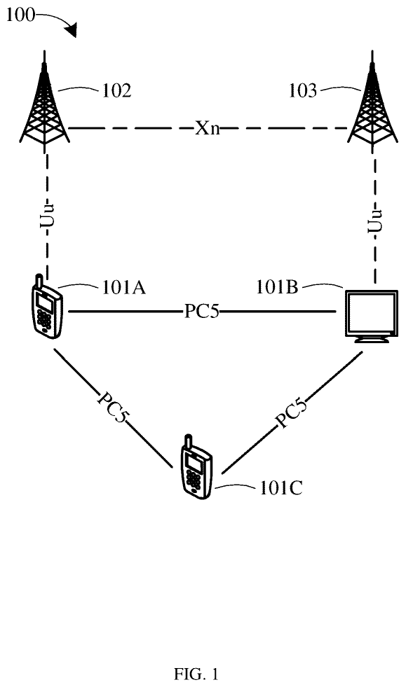

FIG. 1 illustrates a schematic diagram of a wireless communication system 100 in accordance with some embodiments of the present disclosure.

As shown in FIG. 1, the wireless communication system 100 may support sidelink communications. Sidelink communication supports UE-to-UE direct communication. In the context of the present disclosure, sidelink communications may be categorized according to the wireless communication technologies adopted. For example, sidelink communication may include NR sidelink communication and V2X sidelink communication.

NR sidelink communications (e.g., specified in 3GPP specification TS 38.311) may refer to access stratum (AS) functionality enabling at least vehicle-to-everything (V2X) communications as defined in 3GPP specification TS 23.287 between neighboring UEs, using NR technology but not traversing any network node. V2X sidelink communications (e.g., specified in 3GPP specification TS 36.311) may refer to AS functionality enabling V2X communications as defined in 3GPP specification TS 23.285 between neighboring UEs, using evolved-universal mobile telecommunication system (UMTS) terrestrial radio access (UTRA) (E-UTRA) technology, but not traversing any network node. However, if not being specified, “sidelink communications” may refer to NR sidelink communications, V2X sidelink communications, or any sidelink communications adopting other wireless communication technologies.

Referring to FIG. 1, the wireless communication system 100 may include some base stations (e.g., BS 102 and BS 103) and some UEs (e.g., UE 101A, UE 101B, and UE 101C). Although a specific number of UEs and BSs is depicted in FIG. 1, it is contemplated that any number of UEs and BSs may be included in the wireless communication system 100.

The UEs and the BSs may support communication based on, for example, 3G, long-term evolution (LTE), LTE-advanced (LTE-A), new radio (NR), or other suitable protocol(s). In some embodiments of the present disclosure, a BS (e.g., BS 102 or BS 103) may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. A UE (e.g., UE 101A, UE 101B, or UE 101C) may include, for example, but is not limited to, a computing device, a wearable device, a mobile device, an IoT device, a vehicle, etc. Persons skilled in the art should understand that as technology develops and advances, the terminologies described in the present disclosure may change, but should not affect or limit the principles and spirit of the present disclosure.

In the example of FIG. 1, the BS 102 and the BS 103 may be included in a next generation radio access network (NG-RAN). In some embodiments of the present disclosure, the BS 102 may be a gNB and the BS 103 may be an ng-eNB.

The UE 101A and UE 101B may be in-coverage (e.g., inside the NG-RAN). For example, as shown in FIG. 1, the UE 101A may be within the coverage of BS 102, and the UE 101B may be within the coverage of BS 103. The UE 101C may be out-of-coverage (e.g., outside the coverage of the NG-RAN). For example, as shown in FIG. 1, the UE 101C may be outside the coverage of any BS, for example, both the BS 102 and BS 103. The UE 101A and UE 101B may respectively connect to the BS 102 and BS 103 via a network interface, for example, the Uu interface as specified in 3GPP standard documents. The control plane protocol stack in the Uu interface may include a radio resource control (RRC) layer, which may be referred to as a Uu RRC. The link established between a UE (e.g., UE 101A) and a BS (e.g., BS 102) may be referred to as a Uu link. The BS 102 and BS 103 may be connected to each other via a network interface, for example, the Xn interface as specified in 3GPP standard documents. The UE 101A, UE 101B, and UE 101C may be connected to each other respectively via, for example, a PC5 interface as specified in 3GPP standard documents. The control plane protocol stack in the PC5 interface may include a radio resource control (RRC) layer, which may be referred to as a PC5 RRC. The link established between two UEs (e.g., UE 101A and UE 101B) may be referred to as a PC5 link.

Support for V2X services via the PC5 interface can be provided by, for example, NR sidelink communication and/or V2X sidelink communication. NR sidelink communication can support one of the following three types of transmission modes for a pair of a source Layer-2 identity and a destination Layer-2 identity: unicast transmission, groupcast transmission, and broadcast transmission. Sidelink communication transmission and reception over the PC5 interface are supported when the UE is either in-coverage or out-of-coverage. For example, the UE 101A, which is within the coverage of the BS 102, can perform sidelink transmission and reception (e.g., sidelink unicast transmission, sidelink groupcast transmission, or sidelink broadcast transmission) over a PC5 interface. The UE 101C, which is outside the coverage of both the BS 102 and BS 103, can also perform sidelink transmission and reception over a PC5 interface.

A UE which supports sidelink communication and/or V2X communication may be referred to as a V2X UE. A V2X UE may be a cell phone, a vehicle, a roadmap device, a computer, a laptop, an IoT (internet of things) device or other type of device in accordance with some other embodiments of the present disclosure.

As mentioned above, the relaying function based on a sidelink may be supported in a communication network. In some embodiments of the present disclosure, a UE-to-network relay is supported. For example, an in-coverage UE in communication with a remote UE (e.g., an out-of-coverage UE or in-coverage UE) may function as a relay UE between the serving BS of the in-coverage UE and the remote UE. The remote UE may thus access the BS via this relay UE. The data between the remote UE and the BS may be transferred by the relay UE. In this scenario, the relay UE may be referred to as a serving relay of the remote UE, the serving BS or serving cell of the relay UE may be referred to as the serving BS or serving cell of the remote UE, and the path to the BS via the relay UE may be referred to an indirect path.

In some embodiments of the present disclosure, a UE may connect to a network via a multi-path, for example, a direct path and an indirect path. A direct path may mean that the UE communicates with the network without sidelink relaying. An indirect path, as described above, may mean that the UE communicates with the network via a relay UE. A multi-path is advantageous since it may improve network performance, such as reliability, robustness as well as throughput.

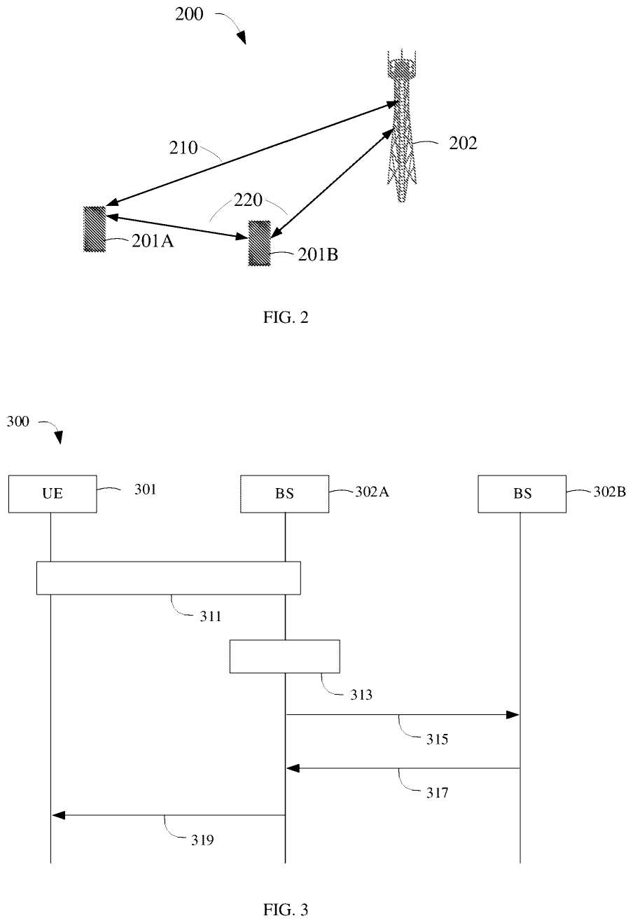

FIG. 2 illustrates a schematic diagram of a wireless communication system 200 in accordance with some embodiments of the present disclosure. Details described in all of the foregoing embodiments of the present disclosure are applicable for the embodiments shown in FIG. 2.

As shown in FIG. 2, the wireless communication system 200 may include a BS (e.g., BS 202) and some UEs (e.g., UE 201A and UE 201B). Although a specific number of UEs and BS is depicted in FIG. 2, it is contemplated that any number of UEs and BSs may be included in the wireless communication system 200.

UE 201B may be within the coverage of BS 202. For example, UE 201B and BS 202 may establish an RRC connection therebetween. The wireless communication system 200 may support sidelink communications. For example, UE 201B may be in sidelink communication with UE 201A. A PC5 RRC connection may be established between UE 201A and UE 201B.

In some embodiments of the present disclosure, UE 201A may initiate a procedure for establishing connection with BS 202 via UE 201B (i.e., UE-to-network relay). For example, UE 201A may transmit an RRC setup request to BS 202 via UE 201B. BS 202 may transmit an RRC setup message including a response to UE 201A via UE 201B. After such procedure, UE 201A may access BS 202 (e.g., a cell of BS 202) via UE 201B. This cell may be referred to as a serving cell of UE 201A. UE 201A and BS 202 may establish an RRC connection therebetween. UE 201A may have RRC states, such as an RRC_IDLE state, an RRC_INACTIVE state, and an RRC_CONNECTED state. UE 201A may also be referred to as a remote UE and UE 201B may also be referred to as a relay UE or a serving relay of UE 201A. For example, as shown in FIG. 2, UE 201A may connect to BS 202 via indirect path 220.

In some examples, UE 201A may be within the coverage of BS 202 and may establish a direct connection with BS 202. For example, as shown in FIG. 2, UE 201A may connect to BS 202 via direct path 210.

It should be appreciated by persons skilled in the art that although a single relay node (e.g., UE 201B) between UE 201A and BS 202 is depicted in FIG. 2, it is contemplated that any number of relay nodes may be included.

Under certain circumstances, a BS (source BS) may hand over a UE served by the BS to another BS (target BS). Embodiments of the present disclosure provide solutions for handing over the UE from a source BS to a target BS. Before the handover, the UE may connect to the source BS via a single path (e.g., a direct path or an indirect path) or multiple paths (e.g., a direct path and an indirect path). The target BS may configure a single path or multiple paths to the UE.

Various issues may occur during such handover process. For example, when and how to transmit the reconfiguration complete message, when to release the source PC5 link (if exists), when to perform the user plane (UP) transmission, how to handle the timers during the handover, and how to determine and handle the success or failure of the handover. Solutions are proposed to solve at least the above-mentioned issues. More details on the embodiments of the present disclosure will be illustrated in the following text in combination with the appended drawings.

FIG. 3 illustrates a flow chart of an exemplary procedure 300 for wireless communications in accordance with some embodiments of the present disclosure.

Details described in all of the foregoing embodiments of the present disclosure are applicable for the embodiments shown in FIG. 3. It should be appreciated by persons skilled in the art that the sequence of the operations in exemplary procedure 300 may be changed and that some of the operations in exemplary procedure 300 may be eliminated or modified, without departing from the spirit and scope of the disclosure.

Referring to FIG. 3, in operation 311, UE 301 may access BS 302A via at least one path. In some examples, UE 301 may access BS 302A via a direct path or an indirect path. For example, UE 301 may access a cell (source cell) of BS 302A without a sidelink relay. For example, UE 301 may access BS 302A via a relay UE. In some examples, UE 301 may access BS 302A via a direct path and an indirect path. UE 301 may be in an RRC connected state. UE 301 may report the measurement results to BS 302A based on the configuration from BS 302A.

In operation 313, BS 302A may determine to handover UE 301 to BS 302B. In operation 315, BS 302A may transmit a handover request to BS 302B. The handover request may include information related to the at least one path (source path) between UE 301 and BS 302A. In some embodiments of the present disclosure, the handover request may include information related to a direct path, an indirect path, or both between UE 301 and BS 302A.

In response to the handover request, BS 302B may, in operation 317, transmit a handover request acknowledgement to BS 302A via, for example, an Xn interface. The handover request acknowledgement may indicate at least one path (target path) associated with BS 302B. For example, the handover request acknowledgement may indicate a direct path to a cell (target cell) of BS 302B. For example, the handover request acknowledgement may indicate an indirect path to a relay (target relay, such as a UE functioned as a relay) served by BS 302B. For example, the handover request acknowledgement may indicate a direct path to a target cell and an indirect path to a target relay.

In response to the handover request acknowledgement, BS 302A may transmit, to UE 301, a reconfiguration message for handover (may also be referred to as “handover command”) in operation 319. The reconfiguration message may include the at least one path associated with BS 302B. For example, the reconfiguration message may indicate a direct path to a target cell served by BS 302B and an indirect path to a target relay served by BS 302B.

In response to receiving the reconfiguration message for handover, UE 301 may perform a handover procedure. For example, in response to the reconfiguration message indicating a direct path to a target cell, UE 301 may perform a random access (RA) procedure with the target cell. For example, in response to the reconfiguration message indicating an indirect path to a target relay, UE 301 may establish a PC5 link with the target relay when the link has not been established.

In some embodiments of the present disclosure, UE 301 may transmit at most one reconfiguration complete message to BS 302B regardless of the number of paths configured in the reconfiguration message for handover. For example, when the reconfiguration message indicates a direct path and an indirect path, UE 301 may transmit at most one reconfiguration complete message to BS 302B.

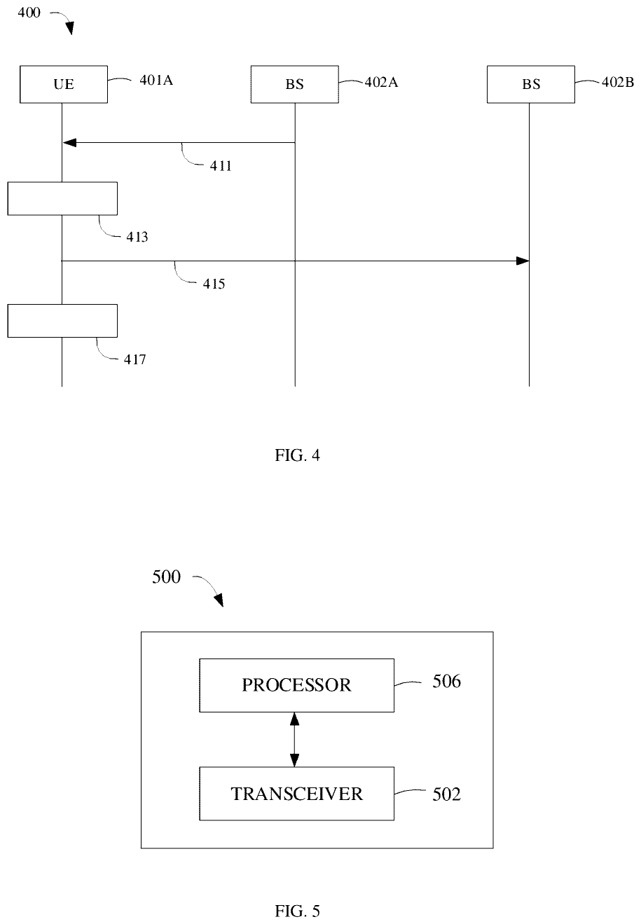

The detailed handover procedure is described with respect to FIG. 4. Details described in all of the foregoing embodiments of the present disclosure are applicable for the embodiments shown in FIG. 4. UE 401, BS 402A, and BS 402B in FIG. 4 may function as UE 301, BS 302A, and BS 302B in FIG. 3, respectively.

Referring to FIG. 4, in operation 411, UE 401 may receive a reconfiguration message for handover from BS 402A (source BS). The description of the reconfiguration message for handover in the foregoing embodiments, for example, with respect to FIG. 3, may apply here. For example, the reconfiguration message may indicate at least one path associated with BS 402B (target BS). For example, the reconfiguration message may indicate a direct path to a cell (target cell) of BS 402B and an indirect path to a relay (target relay) served by BS 302B.

In response to receiving the reconfiguration message for handover, UE 401 may perform a handover procedure based on the reconfiguration message in operation 413. In some examples, when the reconfiguration message indicates a direct path to a target cell, UE 401 may start a timer for direct path establishment (e.g., Timer T304 specified in 3GPP specification TS 38.331). UE 401 may stop the timer for direct path establishment in response to the direct path being successfully established. In some examples, when the reconfiguration message indicates an indirect path to a target cell, UE 401 may start a timer for indirect path establishment. UE 401 may stop the timer for indirect path establishment in response to the indirect path being successfully established. In some examples, the timer for indirect path establishment and the timer for direct-to-indirect path switch may refer to the same timer. In some examples, as will be described below, UE 401 may not start the timer for indirect path establishment (e.g., prohibit starting a timer for indirect path establishment) even when the reconfiguration message indicates an indirect path.

For convenience, the following embodiments are described assuming that the at least one path for handover includes a direct path to a target cell and an indirect path to a target relay. It should be appreciated by persons skilled in the art that the following embodiments can be applied to the case where the at least one path for handover includes less or more handover paths (indirect or direct).

In some embodiments of the present disclosure, the handover may be considered as successful in response to one of the at least one path for handover being successfully established.

In some embodiments, UE 401 may stop the timer for indirect path establishment after UE 401 (successfully) transmits the reconfiguration complete message to BS 402B via one of the direct path and indirect path in operation 415. UE 401 may determine whether the reconfiguration complete message is successfully transmitted or not based on a lower layer acknowledgement from the target cell or target relay.

For example, in response to receiving the reconfiguration message for handover, UE 401 may start a timer for indirect path establishment. Or UE 401 may start a timer for direct path establishment. Or UE 401 may start a timer for indirect path establishment and a timer for indirect path establishment. In some embodiments, when UE 401 successful establishes the direct path, UE 401 may transmit a reconfiguration complete message to BS 402B via the successfully established path. In response to the transmission of the reconfiguration complete message via the successful established direct path (or the successful establishment of the direct path), UE 401 may stop the timer for indirect path establishment (if running). In this way, the timer for indirect path establishment can be well handled.

In some embodiments, the reconfiguration complete message may be transmitted via the indirect path in preference to the direct path. For example, the reconfiguration complete message may be transmitted via the indirect path in response to a link between the UE and the target relay being successfully established. The reconfiguration complete message may be transmitted via the direct path in response to the indirect path being unsuccessfully established (e.g., the timer for indirect path establishment expires).

In some embodiments, UE 401 may establish the indirect path first. In response to completing the establishment of the indirect path (succeeded or failed), UE 401 may start the timer for direct path establishment and may establish the direct path with the target cell.

For example, in response to receiving the reconfiguration message for handover, UE 401 may start a timer for indirect path establishment and may try to switch to the indirect path. When UE 401 successful establishes the indirect path, UE 401 may transmit a reconfiguration complete message to BS 402B via the indirect path (via the target relay to BS 402B). In response to the transmission of the reconfiguration complete message (or the successful establishment of the indirect path), UE 401 may stop the timer for indirect path establishment, and may start the timer for direct path establishment. UE 401 may perform an RA procedure with the target cell to establish the direct path.

In some embodiments, in response to transmitting the reconfiguration complete message, UE 401 may transmit the UP data via the successfully established path(s) in operation 417. In some embodiments, in response to transmitting the reconfiguration complete message, UE 401 may release a source PC5 link (if exists) in operation 417. The source PC5 link may refer to the PC5 link with a relay (source relay) via which UE 401 connects to BS 402A.

Since the handover is considered as successful when one (either the direct path or the indirect path) of the at least one path for handover is successfully established, the expiry of the timer(s) associated with a part of the at least one path (e.g., one of two) will not declare handover failure. In other words, only the expiry of the timers associated with all of the at least one path, for example, both the timer for indirect path establishment and the timer for direct path establishment expires when the at least one path includes an indirect path and direct path, may cause a handover failure. In response to the handover failure, UE 401 may perform a re-establishment procedure.

In some embodiments, in response to one of the direct path and the indirect path being unsuccessfully established (e.g., the corresponding timer expires), UE 401 may transmit failure information related to the failed path via the successfully established path. The failure information may indicate the failed path. For example, the failure information may indicate an ID of the target cell or the target relay with which UE 401 fails to establish a link.

The failure information may be transmitted via a reconfiguration complete message, a UE assistance information message, or an RRC message specific for the failure information. For example, if the failure information has been generated when UE 401 transmits the reconfiguration complete message, the failure information may be included in the reconfiguration complete message.

In some embodiments of the present disclosure, a primary path may be configured. For example, either the direct path or the indirect path of the at least one path for handover can be configured as the primary path. Other path(s) of the at least one path for handover may be referred to as a secondary path. Signaling radio bearer (SRB) 1 and SRB2 may be configured in the primary path. The handover may be considered as successful in response to the primary path being successfully established. The reconfiguration complete message should be transmitted in the primary path. For example, UE 401 may transmit, in operation 415, a reconfiguration complete message via the primary path in response to the primary path being successfully established.

In some embodiments, UE 401 may stop the timer for indirect path establishment after UE 401 (successfully) transmits the reconfiguration complete message to BS 402B via the primary path in operation 415.

For example, in response to receiving the reconfiguration message for handover, UE 401 may start a timer for indirect path establishment. Or UE 401 may start a timer for direct path establishment. Or UE 401 may start a timer for indirect path establishment and a timer for indirect path establishment. In some embodiments, the direct path may be configured as the primary path. When UE 401 successful establishes the direct path, UE 401 may transmit a reconfiguration complete message to BS 402B via the direct path. In response to the transmission of the reconfiguration complete message via the direct path (or the successful establishment of the direct path), UE 401 may stop the timer for indirect path establishment (if running). In this way, the timer for indirect path establishment can be well handled.

In some embodiments, UE 401 may not start the timer for indirect path establishment in response to receiving the reconfiguration message for handover. For example, when the direct path is configured as the primary path, UE 401 may prohibit starting the timer for indirect path establishment in response to receiving the reconfiguration message for handover.

In some embodiments, UE 401 may establish the indirect path first. In response to completing the establishment of the indirect path (succeeded or failed), UE 401 may start the timer for direct path establishment and may establish the direct path with the target cell.

For example, in response to receiving the reconfiguration message for handover, UE 401 may start a timer for indirect path establishment and may try to switch to the indirect path. When the indirect path is configured as the primary path, UE 401 may transmit a reconfiguration complete message to BS 402B via the indirect path in response to the indirect path being successfully established. In response to the successful establishment of the indirect path (or the transmission of the reconfiguration complete message when the indirect path is configured as the primary path), UE 401 may stop the timer for indirect path establishment, and may start the timer for direct path establishment. UE 401 may perform an RA procedure with the target cell to establish the direct path. When the direct path is configured as the primary path, UE 401 may transmit a reconfiguration complete message to BS 402B via the direct path in response to the direct path being successfully established.

In some embodiments, in response to the successful establishment of the primary path or the transmission of the reconfiguration complete message via the primary path, UE 401 may transmit the UP data via the successfully established path(s) in operation 417. In some embodiments, in response to the successful establishment of the primary path or the transmission of the reconfiguration complete message via the primary path, UE 401 may release the source PC5 link (if exists) in operation 417.

In some embodiments, a failure to establish the primary path may cause a handover failure, and a failure to establish the secondary path may not cause a handover failure. For example, in response to the failure to establish the primary path (e.g., the expiry of the timer for primary path establishment, which may be started in response to receiving the reconfiguration message for handover), a handover failure may be declared. In response to the handover failure (or the expiry of the timer for primary path establishment), UE 401 may perform a re-establishment procedure.

For example, when the handover on the primary path is successful and the handover on a secondary path fails, UE 401 may transmit failure information related to the failed secondary path via the successfully established path (e.g., the primary path). The failure information may indicate the failed path. For example, the failure information may indicate an ID of the target cell or the target relay with which UE 401 fails to establish a link.

The failure information may be transmitted via a reconfiguration complete message, a UE assistance information message, or an RRC message specific for the failure information. For example, if the failure information has been generated when UE 401 transmits the reconfiguration complete message via the primary path, the failure information may be included in the reconfiguration complete message.

In some embodiments of the present disclosure, the handover may be considered as successful in response to the direct path of the at least one path for handover being successfully established. SRB1 may be configured in the direct path. The reconfiguration complete should be transmitted in the direct path. For example, UE 401 may transmit, in operation 415, a reconfiguration complete message via the direct path in response to the direct path being successfully established.

In some embodiments, UE 401 may stop the timer for indirect path establishment after UE 401 (successfully) transmits the reconfiguration complete message to BS 402B via the direct path.

For example, in response to receiving the reconfiguration message for handover, UE 401 may start a timer for indirect path establishment. Or UE 401 may start a timer for direct path establishment. Or UE 401 may start a timer for indirect path establishment and a timer for indirect path establishment. When UE 401 successful establishes the direct path, UE 401 may transmit a reconfiguration complete message to BS 402B via the direct path. In response to the transmission of the reconfiguration complete message via the direct path (or the successful establishment of the direct path), UE 401 may stop the timer for indirect path establishment (if running). In this way, the timer for indirect path establishment can be well handled.

In some embodiments, UE 401 may not start the timer for indirect path establishment in response to receiving the reconfiguration message for handover. For example, UE 401 may prohibit starting the timer for indirect path establishment in response to receiving the reconfiguration message for handover.

In some embodiments, UE 401 may establish the indirect path first. In response to completing the establishment of the indirect path (succeeded or failed), UE 401 may start the timer for direct path establishment and may establish the direct path with the target cell.

For example, in response to receiving the reconfiguration message for handover, UE 401 may start a timer for indirect path establishment and may try to switch to the indirect path. In response to the successful establishment of the indirect path, UE 401 may stop the timer for indirect path establishment. In response to completing the establishment of the indirect path, UE 401 may start the timer for direct path establishment, and may perform an RA procedure with the target cell to establish the direct path. UE 401 may transmit a reconfiguration complete message to BS 402B via the direct path in response to the direct path being successfully established.

In some embodiments, in response to the successful establishment of the direct path or the transmission of the reconfiguration complete message via the direct path, UE 401 may transmit the UP data via the successfully established path(s) in operation 417. In some embodiments, in response to the successful establishment of the direct path or the transmission of the reconfiguration complete message via the direct path, UE 401 may release the source PC5 link (if exists) in operation 417.

In some embodiments, a failure to establish the direct path may cause a handover failure, and a failure to establish the indirect path may not cause a handover failure. For example, in response to the failure to establish the direct path (e.g., the expiry of the timer for direct path establishment, which may be started in response to receiving the reconfiguration message for handover), a handover failure may be declared and UE 401 may perform a re-establishment procedure.

For example, when the handover on the direct path is successful and the handover on an indirect path fails, UE 401 may transmit failure information related to the failed indirect path via the successfully established path (e.g., the indirect path). The failure information may indicate the failed indirect path. For example, the failure information may indicate an ID of the target relay with which UE 401 fails to establish a link.

The failure information may be transmitted via a reconfiguration complete message, a UE assistance information message, or an RRC message specific for the failure information. For example, if the failure information has been generated when UE 401 transmits the reconfiguration complete message via the direct path, the failure information may be included in the reconfiguration complete message.

In some embodiments of the present disclosure, the handover may be considered as successful in response to all of the at least one path for handover being successfully established. For example, in response to both the direct path and the indirect path being successfully established, UE 401 may transmit a reconfiguration complete message.

In some embodiments, UE 401 may stop the timer for indirect path establishment after UE 401 (successfully) transmits the reconfiguration complete message to BS 402B via one of the direct path and indirect path in operation 415.

For example, in response to receiving the reconfiguration message for handover, UE 401 may start a timer for indirect path establishment. Or UE 401 may start a timer for direct path establishment. Or UE 401 may start a timer for indirect path establishment and a timer for indirect path establishment. In response to both the direct path and the indirect path being successfully established, UE 401 may transmit a reconfiguration complete message via one of the direct path and indirect path. In some examples, UE 401 may transmit the reconfiguration complete message to BS 402B via the direct path. In response to the transmission of the reconfiguration complete message via the direct path, UE 401 may stop the timer for indirect path establishment (if running). In this way, the timer for indirect path establishment can be well handled.

In some embodiments, the reconfiguration complete message is transmitted via the indirect path.

In some embodiments, UE 401 may establish the direct path first. For example, in response to receiving the reconfiguration message for handover, UE 401 may start a timer for direct path establishment and may try to switch to the direct path. In response to completing the establishment of the direct path (succeeded or failed), UE 401 may establish the indirect path. For example, in response to completing the establishment of the direct path, UE 401 may start a timer for indirect path establishment. In response to both the direct path and the indirect path being successfully established, UE 401 may transmit a reconfiguration complete message via the indirect path.

In some embodiments, in response to transmitting the reconfiguration complete message (i.e., both paths have been successfully established), UE 401 may transmit the UP data via the successfully established path(s) in operation 417. In some embodiments, in response to transmitting the reconfiguration complete message, UE 401 may release a source PC5 link (if exists) in operation 417.

In some embodiments, in response to any one (e.g., the direct path or indirect path) of the at least one path being unsuccessfully established, a handover failure may be declared. For example, in response the expiry of any one of the timers associated with the at least one path for handover (e.g., any one of the timer for direct path establishment and the timer for indirect path establishment), UE 401 may perform a re-establishment procedure.

It should be appreciated by persons skilled in the art that the sequence of the operations in exemplary procedure 400 may be changed and some of the operations in exemplary procedure 400 may be eliminated or modified, without departing from the spirit and scope of the disclosure.

FIG. 5 illustrates a block diagram of an exemplary apparatus 500 according to some embodiments of the present disclosure.

As shown in FIG. 5, the apparatus 500 may include at least one processor 506 and at least one transceiver 502 coupled to the processor 506. The apparatus 500 may be a BS, a relay node or a UE.

Although in this figure, elements such as the at least one transceiver 502 and processor 506 are described in the singular, the plural is contemplated unless a limitation to the singular is explicitly stated. In some embodiments of the present application, the transceiver 502 may be divided into two devices, such as a receiving circuitry and a transmitting circuitry. In some embodiments of the present application, the apparatus 500 may further include an input device, a memory, and/or other components.

In some embodiments of the present application, the apparatus 500 may be a UE. The transceiver 502 and the processor 506 may interact with each other so as to perform the operations with respect to the UEs described in FIGS. 1-4. In some embodiments of the present application, the apparatus 500 may be a relay node. The transceiver 502 and the processor 506 may interact with each other so as to perform the operations with respect to the relay nodes described in FIGS. 1-4. In some embodiments of the present application, the apparatus 500 may be a BS. The transceiver 502 and the processor 506 may interact with each other so as to perform the operations with respect to the BSs described in FIGS. 1-4.

In some embodiments of the present application, the apparatus 500 may further include at least one non-transitory computer-readable medium.

For example, in some embodiments of the present disclosure, the non-transitory computer-readable medium may have stored thereon computer-executable instructions to cause the processor 506 to implement the method with respect to the UEs as described above. For example, the computer-executable instructions, when executed, cause the processor 506 interacting with transceiver 502 to perform the operations with respect to the UEs described in FIGS. 1-4.

In some embodiments of the present disclosure, the non-transitory computer-readable medium may have stored thereon computer-executable instructions to cause the processor 506 to implement the method with respect to the relay nodes as described above. For example, the computer-executable instructions, when executed, cause the processor 506 interacting with transceiver 502 to perform the operations with respect to the relay nodes described in FIGS. 1-4.

In some embodiments of the present disclosure, the non-transitory computer-readable medium may have stored thereon computer-executable instructions to cause the processor 506 to implement the method with respect to the BSs as described above. For example, the computer-executable instructions, when executed, cause the processor 506 interacting with transceiver 502 to perform the operations with respect to the BSs described in FIGS. 1-4.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive, from a first base station (BS), a reconfiguration message for handover, wherein the reconfiguration message indicates a direct path to a target cell and an indirect path to a target relay, and the target cell and the target relay are served by a second BS; and
perform a handover procedure based on the reconfiguration message.

2. The UE of claim 1, wherein the at least one processor is configured to cause the UE to, in response to at least one of the direct path or the indirect path being successfully established, transmit a reconfiguration complete message via the successfully established path.

3. The UE of claim 2, wherein the reconfiguration complete message is transmitted via the indirect path in response to a link between the UE and the target relay being successfully established, or the reconfiguration complete message is transmitted via the direct path in response to the indirect path being unsuccessfully established.

4. The UE of claim 1, wherein one of the direct path or the indirect path is a primary path, and wherein the at least one processor is configured to cause the UE to transmit a reconfiguration complete message via the primary path in response to the primary path being successfully established.

5. The UE of claim 1, wherein the handover is successful based on the direct path being successfully established.

6. The UE of claim 1, wherein the at least one processor is configured to cause the UE to, in response to the direct path and the indirect path being successfully established, transmit a reconfiguration complete message via one of the direct path or the indirect path.

7. (canceled)

8. The UE of claim 2, wherein the at least one processor is configured to cause the UE to:
in response to receiving the reconfiguration message for the handover, start a timer for indirect path establishment; and
stop the timer for the indirect path establishment in response to transmitting the reconfiguration complete message via the direct path or the indirect path.

9. The UE of claim 2, wherein the at least one processor is configured to cause the UE to, in response to transmitting the reconfiguration complete message, at least one of transmit user plane (UP) data or release a PC5 link with a relay via which the UE connects to the first BS.

10. The UE of claim 2, wherein, to perform the handover procedure based on the reconfiguration message, the at least one processor is configured to cause the UE to:
establish the indirect path to the second BS via the target relay; and
in response to completing establishment of the indirect path, establish the direct path with the target cell and start a timer for direct path establishment.

11. The UE of claim 2, wherein the at least one processor is configured to cause the UE to, in response to one of the direct path or the indirect path being unsuccessfully established, transmit information related to a failed path via the successfully established path.

12. The UE of claim 2, wherein the at least one processor is configured to cause the UE to:
in response to receiving the reconfiguration message for the handover, start a first timer for indirect path establishment and a second timer for direct path establishment; and
in response to expiry of the first timer for the indirect path establishment and the second timer for the direct path establishment, perform a reestablishment procedure.

13. The UE of claim 4, wherein the at least one processor is configured to cause the UE to prohibit starting a timer for indirect path establishment in response to receiving the reconfiguration message for the handover.

14. A base station (BS), comprising:
at least one memory; and
at least one processor coupled with the at least one memory and configured to cause the BS to:
receive a handover request for handing over a user equipment (UE) from another BS to the BS; and
transmit a handover request acknowledgement in response to the handover request, wherein the handover request acknowledgement indicates a direct path to a target cell of the BS and an indirect path to a target relay served by the BS.

15. A method performed by a user equipment (UE), the method comprising:
receiving, from a first base station (BS), a reconfiguration message for handover, wherein the reconfiguration message indicates a direct path to a target cell and an indirect path to a target relay, and the target cell and the target relay are served by a second BS; and
performing a handover procedure based on the reconfiguration message.

16. The method of claim 15, wherein one of the direct path or the indirect path is a primary path, and the method further comprising transmitting a reconfiguration complete message via the primary path in response to the primary path being successfully established.

17. The method of claim 15, further comprising, in response to at least one of the direct path or the indirect path being successfully established, transmitting a reconfiguration complete message via the successfully established path.

18. The method of claim 17, further comprising:
in response to receiving the reconfiguration message for the handover, starting a timer for indirect path establishment; and
stopping the timer for the indirect path establishment in response to transmitting the reconfiguration complete message via the direct path or the indirect path.

19. The method of claim 17, further comprising, in response to one of the direct path or the indirect path being unsuccessfully established, transmitting information related to a failed path via the successfully established path.

20. A processor for wireless communication, comprising:
at least one controller coupled with at least one memory and configured to cause the processor to:
receive, from a first base station (BS), a reconfiguration message for handover, wherein the reconfiguration message indicates a direct path to a target cell and an indirect path to a target relay, and the target cell and the target relay are served by a second BS; and
perform a handover procedure based on the reconfiguration message.

21. The processor of claim 20, wherein the at least one controller is configured to cause the processor to, in response to at least one of the direct path or the indirect path being successfully established, transmit a reconfiguration complete message via the successfully established path.
